(19) United States
(12) Patent Application Publication
(10) Pub. No.: US 2019/0048641 A1
(43) Pub. Date: Feb. 14, 2019

(54) VEHICULAR OPENING-CLOSING BODY DRIVING DEVICE

(71) Applicant: Shiroki Corporation, Fujisawa-shi, Kanagawa (JP)

(72) Inventors: Atsushi Muramatsu, Fujisawa-shi, Kanagawa (JP); Yoshiki Sugita, Fujisawa-shi, Kanagawa (JP); Toru Ikoma, Fujisawa-shi, Kanagawa (JP); Kenichi Suzuki, Fujisawa-shi, Kanagawa (JP)

(73) Assignee: Shiroki Corporation, Fujisawa-shi, Kanagawa (JP)

(21) Appl. No.: 16/076,558

(22) PCT Filed: Mar. 21, 2017
(86) PCT No.: PCT/JP2017/011222

§ 371 Date: Aug. 8, 2018

(30) Foreign Application Priority Data
Apr. 12, 2016 (JP) 2016-079670

(51) Int. Cl. E05F 15/697; B60J 1/17; F16H 57/04

(52) U.S. Cl. CPC E05F 15/697; B60J 1/17; B60J 5/0419; F16H 57/045; F16H 57/0424

(57) ABSTRACT

A vehicular opening-closing body driving device that supplies a grease to sliding portions of a drive drum and a drum housing to ensure a smooth performance while ensuring reductions of manufacturing cost, manufacturing time, and manufacturing process is provided. The vehicular opening-closing body driving device includes a drive drum, a drum housing, and sliding portions. A drive wire is wound around the drive drum. The drive wire is a wire for driving a vehicular opening-closing body. The drum housing rotatably houses and supports the drive drum. A sliding portion is disposed between a bottom surface of the drum housing and a facing surface of the drive drum. The facing surface faces the bottom surface. The drum housing includes a grease supply hole for supplying a grease to the sliding portion.

### TECHNICAL FIELD

The present invention relates to a vehicular opening-closing body driving device.

### BACKGROUND ART

A window regulator (a vehicular opening-closing body driving device) has a basic configuration that includes a guide rail extending in a longitudinal direction, a slider base that is supported to this guide rail so as to be freely movable up and down and a window glass (a vehicular opening-closing body) is supported to the slider base, a drive wire to move this slider base up and down and drive along the guide rail, a drive drum around which this drive wire is wound, a drum housing that rotatably houses and supports this drive drum, and a motor unit that is supported to this drum housing and rotatably drives the drive drum.

Manufacturing this type of window regulator requires a process for supplying a grease between relatively moving members, for example, sliding portions of the guide rail and the slider base mutually moving up and down, and sliding portions of the drive drum and the drum housing which mutually moving while rotating. The sliding portion includes, for example, a protrusion (a slide bead) that projects from one of the mutually moving members toward the other.

Conventionally, in the process for supplying the grease to the sliding portions of the drive drum and the drum housing, the grease is applied over the protrusion (the sliding portion, the slide bead) of the drum housing before the drive drum is housed and supported to the drum housing, subsequently, the drive drum is housed and supported to the drum housing, and the motor unit is secured to the drum housing.
Patent Document 1: JP-A-2010-150763

### DISCLOSURE OF THE INVENTION

### Problems to be Solved by the Invention

However, the above-described conventional window regulator (the vehicular opening-closing body driving device) separately requires equipment for applying the grease over the protrusion (the sliding portion, the slide bead) of the drum housing and equipment for supporting the drive drum and the motor unit to the drum housing, thus causing increase in manufacturing cost and manufacturing process.

A time difference occurs between the process for supplying the grease to the sliding portions of the guide rail and the slider base and the process for supplying the grease to the sliding portions of the drive drum and the drum housing, thus causing increase in manufacturing time and manufacturing process.

The present invention has been made based on the above-described awareness on the problem, and it is an object of the present invention to provide a vehicular opening-closing body driving device that ensures a smooth performance by supplying the grease to the sliding portions of the drive drum and the drum housing while ensuring reductions of manufacturing cost, manufacturing time, and manufacturing process.

### Solutions to the Problems

A vehicular opening-closing body driving device of the present invention includes a drive drum and a drum housing. A drive wire is wound around the drive drum. The drive wire is a wire for driving a vehicular opening-closing body. The drum housing rotatably houses and supports the drive drum. A sliding portion is disposed between a bottom surface of the drum housing and a facing surface of the drive drum. The facing surface faces the bottom surface. The drum housing includes a grease supply hole for supplying a grease to the sliding portion.

The drum housing can include a grease storage recess on a peripheral area of the grease supply hole.

The drive drum can include a grease storage recess on a position facing the grease supply hole.

The sliding portion on the drum housing side can include a circular protrusion protruding from the drum housing toward the drive drum. The circular protrusion slides with respect to the facing surface. The grease supply hole is surrounded by the protrusion.

The grease storage recess can have a shape tapered toward a direction in which the drive drum rotates with respect to the drum housing.

The vehicular opening-closing body driving device of the present invention can further include a motor unit supported to the drum housing. The motor unit rotates the drive drum. The drive drum includes a shaft fitting hole and an inward projecting piece inwardly projecting from the shaft fitting hole. The motor unit includes a cover and a fitting shaft. The cover covers a housing-supporting portion of the drum housing. The fitting shaft projects from the cover and fit to the shaft fitting hole of the drive drum. A clearance between the fitting shaft of the motor unit and the inward projecting piece of the drive drum is smaller than a clearance between the cover of the motor unit and the drive drum.

### Effects of the Invention

According to the present invention, a vehicular opening-closing body driving device that supplies a grease to sliding portions of a drive drum and a drum housing to ensure a smooth performance while ensuring reductions of manufacturing cost, manufacturing time, and manufacturing process can be provided.

### BRIEF DESCRIPTION OF THE DRAWINGS

FIG. 1 is a front view of a window regulator (a vehicular opening-closing body driving device) according to this embodiment.

FIG. 2 is a back view of the window regulator (the vehicular opening-closing body driving device) according to the embodiment.

FIG. 3 is a perspective view of a drive drum.

FIG. 4 is a side view of the drive drum viewing in a direction perpendicular to a rotation axis.

FIG. 5 is a perspective view illustrating a configuration of a drum housing.

FIG. 6 is a plan view illustrating the configuration of the drum housing.

FIG. 7 is a cross-sectional view taken along a line VII-VII in FIG. 6.

FIG. 8 is a cross-sectional view illustrating an assembling portion of a motor unit, the drive drum, and the drum housing.

### DESCRIPTION OF PREFERRED EMBODIMENTS

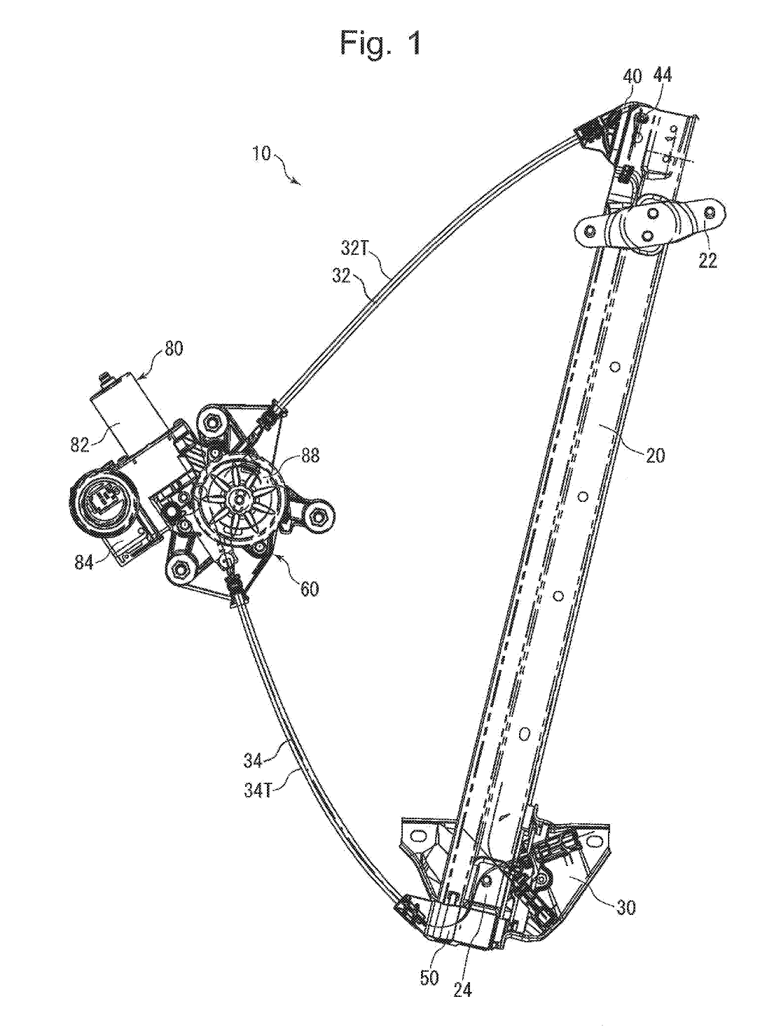

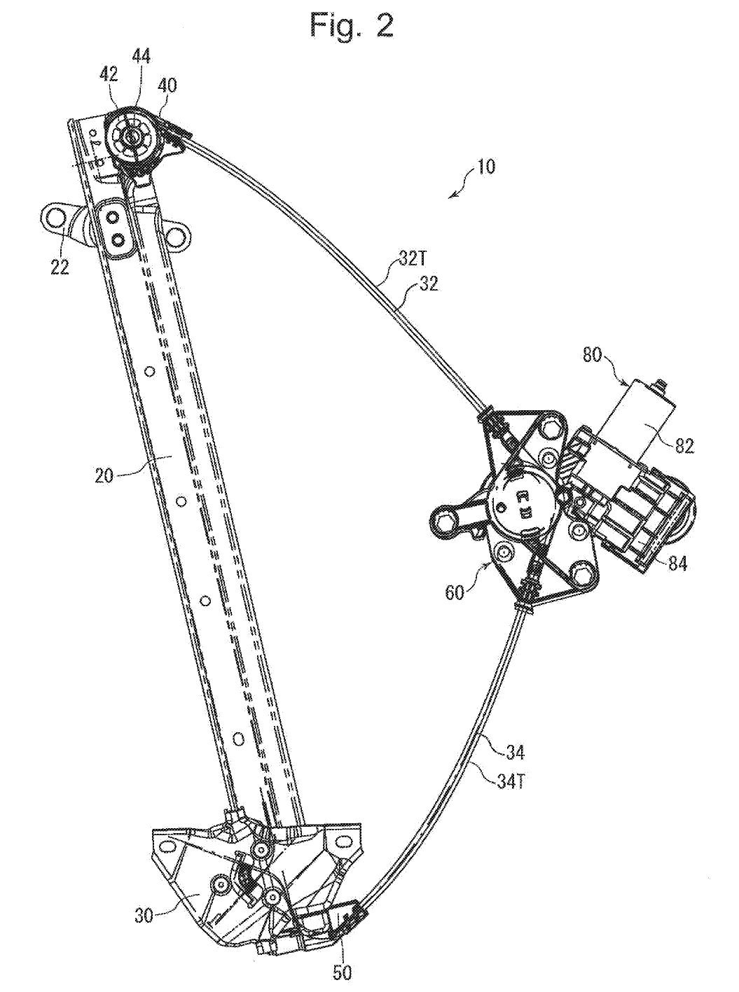

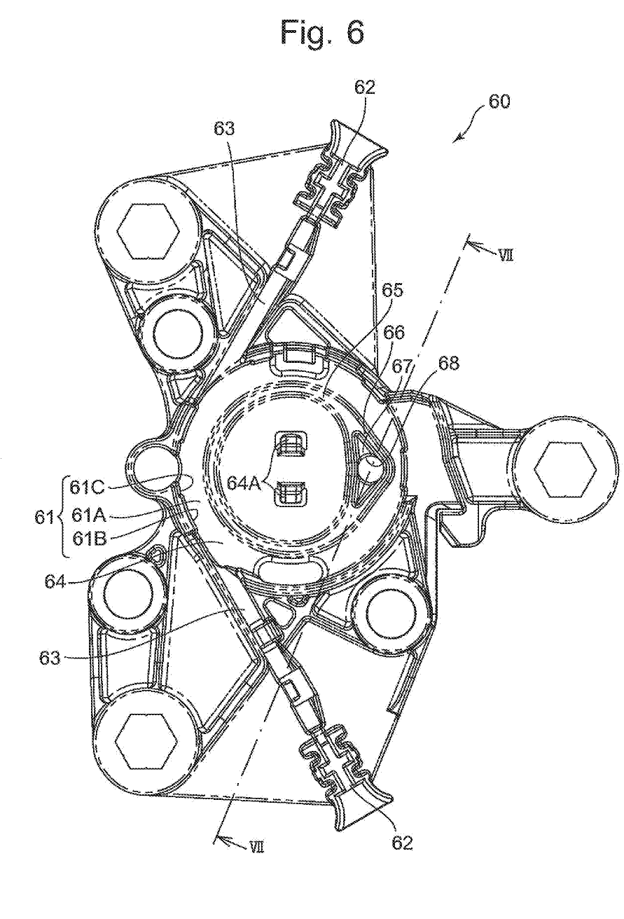

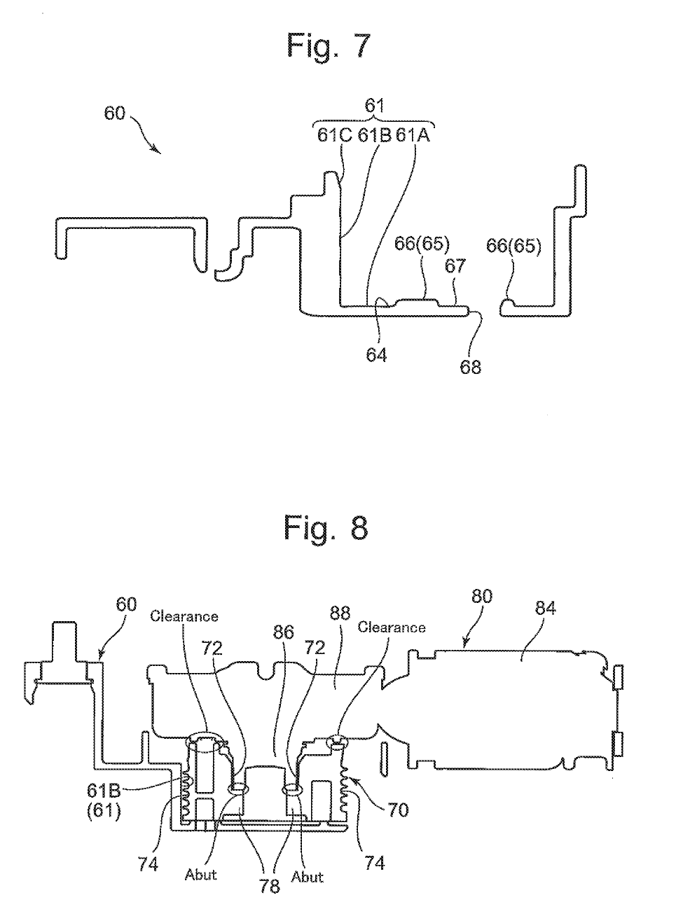

With reference to FIG. 1 to FIG. 8, a window regulator (a vehicular opening-closing body driving device) 10 according to the embodiment will be described.

The window regulator 10 includes a guide rail 20 as an elongated member. This guide rail 20 is mounted to an inside of a door panel (not illustrated) of a vehicle via brackets 22 and 24 disposed on different positions in a longitudinal direction. The guide rail 20 is arranged having the longitudinal direction in an almost height direction of the vehicle in a state of being mounted to the door panel of the vehicle.

The window regulator 10 includes a slider base (a glass carrier) 30 that is supported to the guide rail 20 so as to be freely movable up and down, and a window glass (a not illustrated vehicular opening-closing body) is supported to the slider base 30. Respective one ends of a pair of drive wires 32 and 34 are coupled to this slider base 30.

A pulley bracket 40 is secured adjacent to an upper end in the longitudinal direction of the guide rail 20, and a guide pulley 42 is rotatably supported to this pulley bracket 40 via a pulley support shaft 44. The drive wire 32 extends from the slider base 30 in an upward direction of the guide rail 20 along the guide rail 20, and is supported by a wire guide groove formed on an outer peripheral surface of the guide pulley 42. Corresponding to advance and retreat of the drive wire 32, the guide pulley 42 rotates around the pulley support shaft 44.

A wire guide member 50 is disposed adjacent to a lower end in the longitudinal direction of the guide rail 20. The drive wire 34 extends from the slider base 30 in a downward direction of the guide rail 20 along the guide rail 20, and is guided by the wire guide member 50. The wire guide member 50 is secured to the guide rail 20, and the drive wire 34 is supported such that the drive wire 34 is configured to advance and retreat along a wire guide groove formed on the wire guide member 50.

The drive wire 32 coming out from the guide pulley 42 is inserted through a tubular outer tube 32T and wound around a drive drum 70 disposed inside a drum housing 60 to which the outer tube 32T is coupled. The drive wire 34 coming out from the wire guide member 50 is inserted through a tubular outer tube 34T and wound around the drive drum 70 disposed inside the drum housing 60 to which the outer tube 34T is coupled.

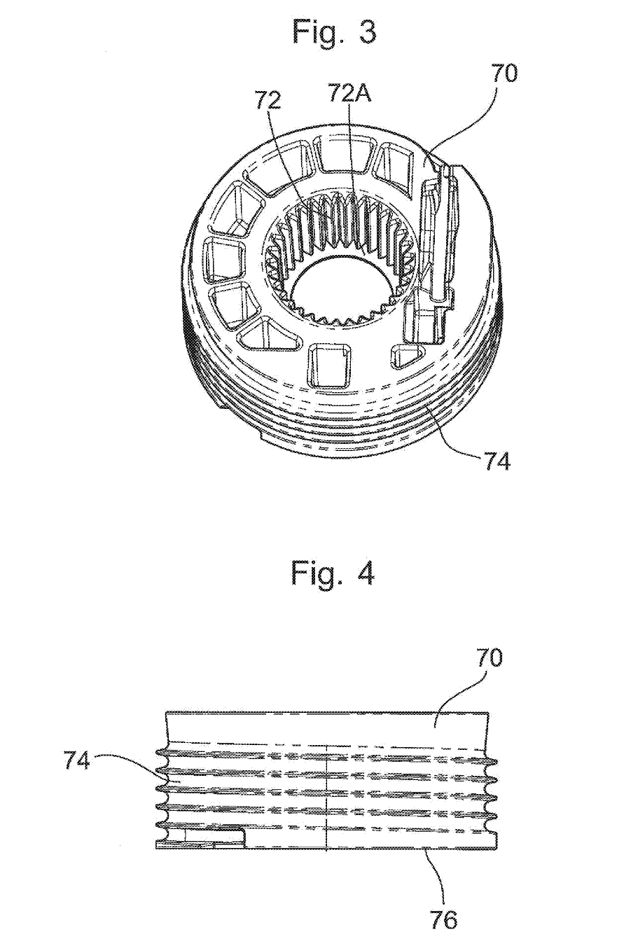

As illustrated in FIG. 3 and FIG. 4, the drive drum 70 has a columnar shape, and includes a shaft fitting hole 72 passing through in an axial direction in the center portion. This shaft fitting hole 72 has an inner surface on which sawtooth-shaped serrations are formed. The drive drum 70 has an outer peripheral surface on which a spiral groove 74 is formed, and the drive wire 32 and the drive wire 34 are wound around the spiral groove 74. This spiral groove 74 varies the position in the axial direction of the drive drum 70 while circling along the outer peripheral surface of the drive drum 70. A portion excluding the shaft fitting hole 72 on a surface of the drive drum 70 facing the drum housing 60 side constitutes a circular planar sliding portion (a sliding portion) 76. In other words, the planar sliding portion (the sliding portion) 76 is a facing surface facing a bottom portion (a bottom surface) 61A (a bottom surface of a drum housing portion 61) of the drum housing 60 described later.

A motor unit 80 is mounted to the drum housing 60. The motor unit 80 includes a motor 82, a gear box 84 having a built-in reduction gear train that transmits rotation of an output shaft of this motor 82 while decreasing the rotation, and a fitting shaft 86 (see FIG. 8) to which a rotary driving force of the motor 82 is transmitted via the reduction gear train of this gear box 84. The motor unit 80 includes a cover 88 that covers an opening portion (a housing opening 61C of the drum housing portion 61 described later) of the drum housing 60, and the fitting shaft 86 projects from the cover 88 and fits to the shaft fitting hole 72 of the drive drum 70. The fitting shaft 86 has serrations fitting to the serrations of the shaft fitting hole 72, and driving the motor 82 in this fitting state rotates the drive drum 70 together with the fitting shaft 86 (see FIG. 8).

The outer tube 32T has one end coupled to the pulley bracket 40 and the other end coupled to the drum housing 60, and the drive wire 32 is configured to advance and retreat in the outer tube 32T having thus determined both end positions. The outer tube 34T has one end coupled to the wire guide member 50 and the other end coupled to the drum housing 60, and the drive wire 34 is configured to advance and retreat in the outer tube 34T having thus determined both end positions.

The drum housing 60 is secured to the door panel (not illustrated) of the vehicle. When the driving force of the motor 82 positively/reversely rotates the drive drum 70, one of the drive wire 32 and the drive wire 34 increases a winding amount around the spiral groove 74 of the drive drum 70, and the other is drawn out from the spiral groove 74 of the drive drum 70, thus causing the slider base 30 to move along the guide rail 20 due to a relationship of pulling and loosening between the drive wire 32 and the drive wire 34. Corresponding to the move of the slider base 30, the window glass (the not illustrated vehicular opening-closing body) moves up and down.

The following describes a housing-supporting structure for rotatably housing and supporting the drive drum 70 to the drum housing 60 in detail.

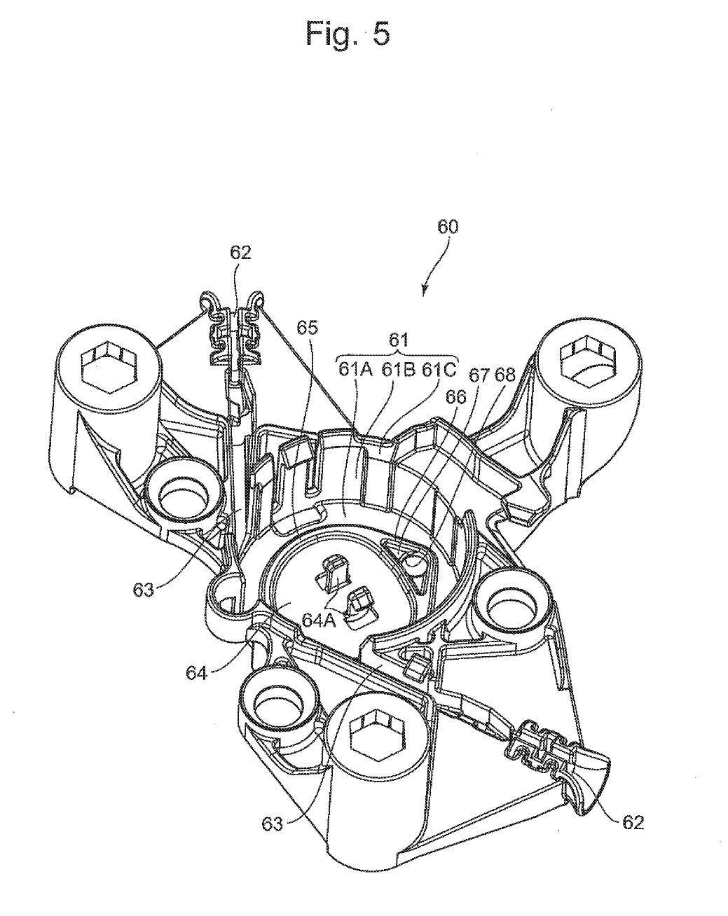

As illustrated in FIG. 5 to FIG. 8, the drum housing 60 includes the drum housing portion 61 and a pair of outer tube insertion portions 62. The drum housing portion 61 has a space surrounded by the bottom portion 61A and a cylindrically-shaped rising wall 61B formed on a peripheral edge of the bottom portion 61A, and has a side opening as a housing opening 61C on an opposite side of the bottom portion 61A. The drum housing 60 includes a pair of wire passage grooves 63, which are communicated with the drum housing portion 61, in mutually different directions (directions of the pulley bracket 40 and the wire guide member 50 in a completed state of the window regulator 10), and the pair of outer tube insertion portions 62 are formed on distal ends of the pair of wire passage grooves 63.

The bottom portion 61A of the drum housing 60 includes a drum support base 64 formed in an approximately circular shape in plan view. The drive drum 70 is inserted into the drum housing portion 61 in a state where the planar sliding portion (the sliding portion) 76 is placed on the drum support base 64. The drum support base 64 includes a shaft protrusion 64A in a bifurcated shape in the center, and the drive drum 70 includes a smooth cylindrical surface 72A on a part of the shaft fitting hole 72 (FIG. 3). Inserting the shaft protrusion 64A into the cylindrical surface 72A to bring both into sliding contact rotatably houses and supports the drive drum 70 to the drum housing 60. Transmission of the driving force of the motor 82 causes the drive drum 70 to rotate around its own rotation axis.

The bottom portion (the bottom surface) 61A of the drum housing 60 includes a slide bead (a sliding portion, a protrusion) 65 in an approximately circular shape in plan view so as to surround the shaft protrusion 64A of the drum support base 64. This slide bead 65 projects toward the planar sliding portion (the sliding portion) 76 of the drive drum 70 in a state where the drive drum 70 is housed and supported to the drum housing 60. That is, the sliding portions of the drum housing 60 and the drive drum 70 are formed while being positioned between the bottom portion (the bottom surface) 61A of the drum housing 60 and the planar sliding portion (the sliding portion) 76 as a facing surface of the drive drum 70, and the facing surface faces this bottom portion (the bottom surface) 61A (the circular protrusion of the drum housing slides with respect to the facing surface of the drive drum).

The slide bead 65 includes a triangular corner portion 66 bulging to an outer peripheral side on a part in a circumferential direction, and this triangular corner portion 66 internally includes a grease storage recess 67 in a triangular shape corresponding to the triangular corner portion 66. This grease supply recess 67 has one apex of the triangle positioned on an outer peripheral side of the slide bead 65, and the other two apexes of the triangle positioned in the circumferential direction (the direction in which the drive drum 70 rotates with respect to the drum housing 60) of the slide bead 65 and having shapes tapered toward the circumferential direction of the slide bead 65. Furthermore, this grease storage recess 67 includes a grease supply hole 68 in an approximately circular shape on the center. That is, the grease storage recess 67 is formed on a peripheral area of the grease supply hole 68 of the drum housing 60. The grease supply hole 68 of the drum housing 60 is surrounded by the slide bead (the protrusion) 65.

The grease supply hole 68 has a function to supply grease between the planar sliding portion (the sliding portion) 76 and the slide bead (the sliding portion, the protrusion) 65 as the sliding portions of the drive drum 70 and the drum housing 60 in a state where the drive drum 70 is rotatably housed and supported to the drum housing 60. The grease storage recess 67 has a function to store the grease supplied from the grease supply hole 68.

In the state where the drive drum 70 is rotatably housed and supported to the drum housing 60, supplying the grease from the grease supply hole 68 causes the grease to be once stored in the grease storage recess 67. In this grease storage state, rotating the drive drum 70 with respect to the drum housing 60 causes the grease stored in the grease storage recess 67 to be supplied between the planar sliding portion (the sliding portion) 76 and the slide bead (the sliding portion, the protrusion) 65 as the sliding portions of the drive drum 70 and the drum housing 60, thus getting fitted between them.

Thus, according to the embodiment, the grease supply hole 68 disposed on the drum housing 60 can supply the grease between the planar sliding portion (the sliding portion) 76 and the slide bead (the sliding portion, the protrusion) 65 as the sliding portions of the drive drum 70 and the drum housing 60 in the state where the drive drum 70 is rotatably housed and supported to the drum housing 60. This ensures the smooth performances of the drive drum 70 and the drum housing 60, and the reductions of manufacturing cost, manufacturing time, and manufacturing process.

Disposing the grease storage recess 67 on the drum housing 60 to supply the grease via this grease storage recess 67 eliminates the grease scattered to be wasted (reduces an injection amount of the grease), and ensures accurate and uniform grease supply (application). In addition, the equipment on the grease injection side does not require precise control, thus providing an advantage that it is only necessary to simply inject the grease into the grease storage recess 67.

The grease storage recess 67 disposed on the drum housing 60, which is configured not to move with respect to the drive drum 70, provides advantages that the grease is easily stored while the occurrence of an abnormal noise is prevented and a need for positioning of the drum housing 60 is eliminated.

Furthermore, since the two apexes of the triangle of the grease supply recess 67 are positioned in the circumferential direction (the direction in which the drive drum 70 rotates with respect to the drum housing 60) of the slide bead 65 and having shapes tapered toward the circumferential direction of the slide bead 65, the grease stored in the grease storage recess 67 is prevented from being scattered to be wasted, thus ensuring the accurate and uniform grease supply (application).

FIG. 8 is a cross-sectional view illustrating an assembling portion of the motor unit 80, the drive drum 70, and the drum housing 60. As illustrated in FIG. 8, the shaft fitting hole 72 of the drive drum 70 includes an inwardly projecting inward projecting piece 78 on the lower portion (the cylindrical surface 72A). When the motor unit 80 is supported to the drum housing 60, a distal end of the fitting shaft 86 of the motor unit 80 abuts on the inward projecting piece 78 of the drive drum 70. On the other hand, a clearance is disposed between a lower end portion of the cover 88 of the motor unit 80 and an upper end portion of the drive drum 70 so as to prevent a contact of both members. In a conventional window regulator, since the lower end portion of the cover of the motor unit contacts the upper end portion of the drive drum, the grease is generally applied between these members. In contrast, in the window regulator 10 of the embodiment, since the clearance is disposed between the lower end portion of the cover 88 of the motor unit 80 and the upper end portion of the drive drum 70 to prevent the contact of both members, a need for applying the grease between both members is eliminated, thus ensuring simplifying and shortening the manufacturing process, and ensuring the cost reduction.

As a modification (a wider technical idea) of FIG. 8, a clearance between the distal end of the fitting shaft 86 of the motor unit 80 and the inward projecting piece 78 of the drive drum 70 is simply configured to be smaller than the clearance between the lower end portion of the cover 88 of the motor unit 80 and the upper end portion of the drive drum 70.

While, in the above-described embodiment, the description has been given of the exemplary case where the grease storage recess 67 is disposed on the drum housing 60, an aspect where the grease storage recess is disposed on the drive drum 70, and further, an aspect where the grease storage recess is disposed over both the drum housing 60 and the drive drum 70 may be employed. This aspect has a positional relationship where the grease storage recess formed on the drive drum 70 faces the grease supply hole 68 formed on the drum housing 60.

While, in the above-described embodiment, the description has been given of the exemplary case where the slide bead (the sliding portion, the protrusion) 65 is disposed on the drum housing 60 and the planar sliding portion (the sliding portion) 76 is disposed on the drive drum 70, this positional relationship may be conversely configured so as to employ an aspect where the slide bead (the sliding portion, the protrusion) is disposed on the drive drum 70 and the planar sliding portion (the sliding portion) is disposed on the drum housing 60.

In the above-described embodiment, the description has been given of the exemplary case where the grease storage recess 67 and the grease supply hole 68 are formed on the slide bead (the sliding portion, the protrusion) 65 of the drum housing 60. However, an aspect where only one of the grease storage recess 67 and the grease supply hole 68 is formed on the slide bead (the sliding portion, the protrusion) 65 of the drum housing 60 and the other is formed on a position other than the slide bead (the sliding portion, the protrusion) 65 may be employed.

While, in the above-described embodiment, the description has been given of the exemplary case where the vehicular opening-closing body driving device of the present invention is applied to the window regulator 10, the vehicular opening-closing body driving device of the present invention is similarly applicable to a vehicular opening-closing body driving device other than the window regulator 10.

### INDUSTRIAL APPLICABILITY

The vehicular opening-closing body driving device of the present invention is preferably applied to, for example, a window regulator configured to move a window glass of a vehicle up and down.

### DESCRIPTION OF REFERENCE SIGNS

10 window regulator (vehicular opening-closing body driving device)
20 guide rail
22 bracket
24 bracket
30 slider base (glass carrier)
32 drive wire
32T outer tube
34 drive wire
34T outer tube
40 pulley bracket
42 guide pulley
44 pulley support shaft
50 wire guide member
60 drum housing
61 drum housing portion
61A bottom portion (bottom surface)
61B rising wall
61C housing opening
62 outer tube insertion portion
63 wire passage groove
64 drum support base
64A shaft protrusion
65 slide bead (sliding portion, protrusion)
66 triangular corner portion
67 grease storage recess
68 grease supply hole
70 drive drum
72 shaft fitting hole
72A cylindrical surface
74 spiral groove
76 planar sliding portion (sliding portion)
80 motor unit
82 motor
84 gear box
86 fitting shaft
88 cover

1. A vehicular opening-closing body driving device comprising:
a drive drum around which a drive wire is wound, the drive wire being a wire for driving a vehicular opening-closing body;
a drum housing that rotatably houses and supports the drive drum; and
a sliding portion disposed between a bottom surface of the drum housing and a facing surface of the drive drum, the facing surface facing the bottom surface, wherein
the drum housing includes a grease supply hole for supplying a grease to the sliding portion.

2. The vehicular opening-closing body driving device according to claim 1, wherein
the drum housing includes a grease storage recess on a peripheral area of the grease supply hole.

3. The vehicular opening-closing body driving device according to claim 1, wherein
the drive drum includes a grease storage recess on a position facing the grease supply hole.

4. The vehicular opening-closing body driving device according to claim 1, wherein
the sliding portion on the drum housing side includes a circular protrusion protruding from the drum housing toward the drive drum,
the circular protrusion slides with respect to the facing surface, and
the grease supply hole is surrounded by the protrusion.

5. The vehicular opening-closing body driving device according to claim 2, wherein
the grease storage recess has a shape tapered toward a direction in which the drive drum rotates with respect to the drum housing.

6. The vehicular opening-closing body driving device according to claim 1, further comprising
a motor unit supported to the drum housing, the motor unit rotating the drive drum, wherein
the drive drum includes a shaft fitting hole and an inward projecting piece inwardly projecting from the shaft fitting hole,
the motor unit includes a cover and a fitting shaft, the cover covering a housing-supporting portion of the drum housing, the fitting shaft projecting from the cover and fitting to the shaft fitting hole of the drive drum, and
a clearance between the fitting shaft of the motor unit and the inward projecting piece of the drive drum is smaller than a clearance between the cover of the motor unit and the drive drum.
